(19) United States
(12) Patent Application Publication
(10) Pub. No.: US 2023/0067265 A1
(43) Pub. Date: Mar. 2, 2023

(54) FORCE-DIRECTED NETWORK CALENDAR

(71) Applicant: INTERNATIONAL BUSINESS MACHINES CORPORATION, ARMONK, NY (US)

(72) Inventors: Lisa Seacat DeLuca, Bozeman, MT (US); Kelley Anders, East New Market, MD (US); Jonathan D. Dunne, Dungarvan (IE)

(21) Appl. No.: 17/411,196

(22) Filed: Aug. 25, 2021

(51) Int. Cl. G06Q 10/10; G06F 16/2457

(52) U.S. Cl. CPC G06Q 10/1095; G06F 16/24578

(57) ABSTRACT

A method, computer system, and a computer program product for directed calendaring is provided. The present invention may include generating a topic model for each of a plurality of previously conducted meetings based on calendar data for a plurality of users. The present invention may include receiving a scheduled meeting, the scheduled meeting including an initial recipient list. The present invention may include generating a new topic model for the scheduled meeting. The present invention may include identifying a previous meeting with a highest similarity score between the topic model and the new topic model for each of the plurality of users. The present invention may include adjusting the initial recipient list of the scheduled meeting based on a transition matrix.

### BACKGROUND

The present invention relates generally to the field of computing, and more particularly to calendaring.

An online calendar may be a web application allowing one or more users to create and schedule online meetings and/or events, among other things. The online meetings and/or events may be set up such that they recur daily, weekly, monthly, or yearly, among other intervals. Invites to the online meetings and/or events may be sent based on at least a predetermined mailing list, subscriber list, and/or job role, amongst other criteria. Invitees may choose to accept or decline the online meeting and/or event based on at least scheduling conflicts, attendance requirements, subject matter, and/or personal circumstances, among other reasons.

This may lead to unproductive online meetings and/or events for one or more individuals. Accordingly, there is a need for adjusting invitee recipient lists for online meetings and/or events based on likely attendance and participation.

### SUMMARY

Embodiments of the present invention disclose a method, computer system, and a computer program product for directed calendaring. The present invention may include generating a topic model for each of a plurality of previously conducted meetings based on calendar data for a plurality of users. The present invention may include receiving a scheduled meeting, the scheduled meeting including an initial recipient list. The present invention may include generating a new topic model for the scheduled meeting. The present invention may include identifying a previous meeting with a highest similarity score between the topic model and the new topic model for each of the plurality of users. The present invention may include adjusting the initial recipient list of the scheduled meeting based on a transition matrix.

Accordingly, the present invention may improve directing scheduled meetings to users with a greater likelihood of attending and participation by adjusting the initial recipient list of a scheduled meeting based on a transition matrix. The transition matrix may be a probability of a user transitioning from a passive to an active state in the scheduled meeting. Furthermore, the transition matrix may be based on at least participation of the user in the previous meeting with the highest similarity score and a position of the user within a hierarchal organization structure.

The present invention may include absorbing, to an adjusted recipient list, each user where the transition matrix exceeds a threshold and deflecting, from the adjusted recipient list, each user where the transition matric is less than or equal to the threshold. Accordingly, the present invention may improve at least, directed invitee recipient lists, which may allow users of an organization to increase production by only receiving meeting invitations in which the user is likely to be active.

The present invention may include sending a notification to each user deflected from the adjusted recipient list, the notification including an option to monitor a chat transcript of the scheduled meeting, wherein the chat transcript is generated in real time. Accordingly, the present invention may improve the ability of a user to passively monitor a scheduled meeting without being in attendance.

The present invention may include determining a topic profile for each of the plurality of users, generating a chat transcript for the meeting in real time, and sending a notification to join the scheduled meeting to one or more absent users based on at least the chat transcript and topic profile of the one or more users. Accordingly, the present invention may improve user collaboration and productivity by notifying users of meetings within the organization that may be of interest to the user and/or meetings in which the user may be able to provide substantive input.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for directed calendaring according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for direct calendaring. As such, the present embodiment has the capacity to improve the technical field of calendaring by absorbing and/or deflecting users from a scheduled meeting using a transition matrix generated by a force-directed conditional calendar model. More specifically, the present invention may include generating a topic model for each of a plurality of previously conducted meetings based on calendar data for a plurality of users. The present invention may include receiving a scheduled meeting, the scheduled meeting including an initial recipient list. The present invention may include generating a new topic model for the scheduled meeting. The present invention may include identifying a previous meeting with a highest similarity score between the topic model and the new topic model for each of the plurality of users. The present invention may include adjusting the initial recipient list of the scheduled meeting based on a transition matrix.

As described previously, an online calendar may be a web application allowing one or more users to create and schedule online meetings and/or events, among other things. The online meetings and/or events may be set up such that they recur daily, weekly, monthly, or yearly, among other intervals. Invites to the online meetings and/or events may be sent based on at least a predetermined mailing list, subscriber list, and/or job role, amongst other criteria. Invitees may choose to accept or decline the online meeting and/or event based on at least scheduling conflicts, attendance requirements, subject matter, and/or personal circumstances, among other reasons.

This may lead to unproductive online meetings and/or events for one or more individuals. Accordingly, there may be a need for adjusting invitee recipient lists for online meetings and/or events based on likely attendance and participation.

Therefore, it may be advantageous to, among other things, generate a topic model for each of a plurality of previously conducted meetings based on calendar data for a plurality of users, receive a scheduled meeting, the scheduled meeting including an initial recipient list, generate a new topic model for the scheduled meeting, identifying a previous meeting with a highest similarity score between the topic model and the new topic model for each of the plurality of users, and adjust the initial recipient list of the scheduled meeting based on a transition matrix.

Accordingly, the present invention may improve directing scheduled meetings to users with a greater likelihood of attending and participation by adjusting the initial recipient list of a scheduled meeting based on a transition matrix.

Accordingly, the present invention may improve at least, directed invitee recipient lists, which may allow users of an organization to increase production by only receiving meeting invitations in which the user is likely to be active.

Accordingly, the present invention may improve the ability of a user to passively monitor a scheduled meeting without being in attendance.

Accordingly, the present invention may improve user collaboration and productivity by notifying users of meetings within the organization that may be of interest to the user and/or meetings in which the user may be able to provide substantive input.

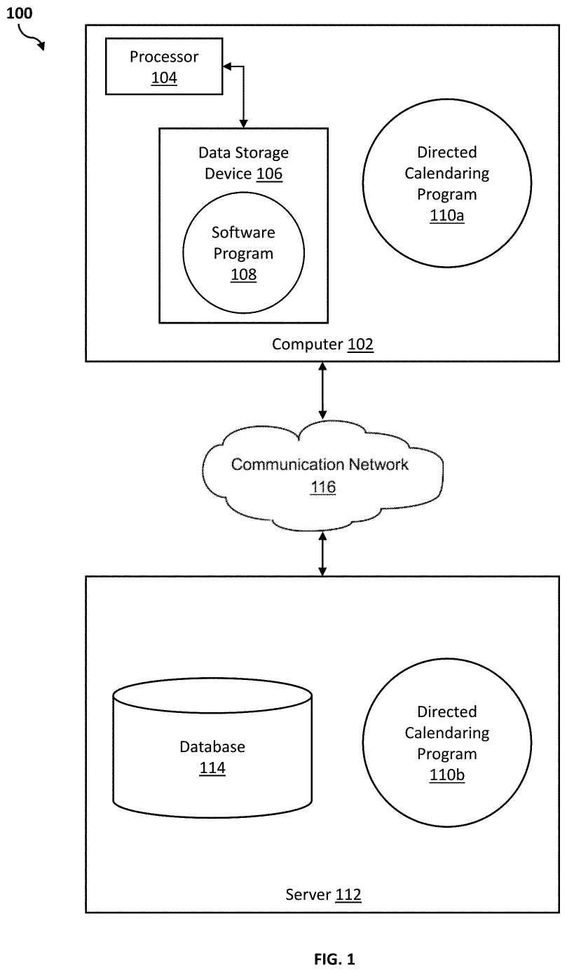

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a directed calendaring program 110a. The networked computer environment 100 may also include a server 112 that is enabled to run a directed calendaring program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

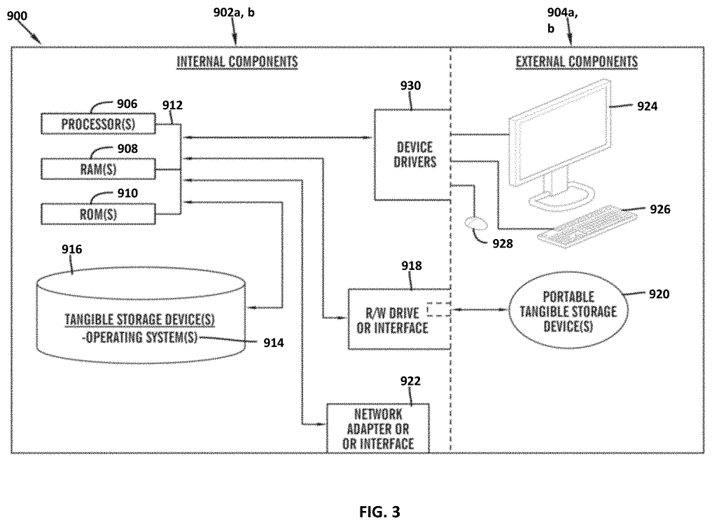

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the directed calendaring program 110a, 110b may interact with a database 114 that may be embedded in various storage devices, such as, but not limited to a computer/mobile device 102, a networked server 112, or a cloud storage service.

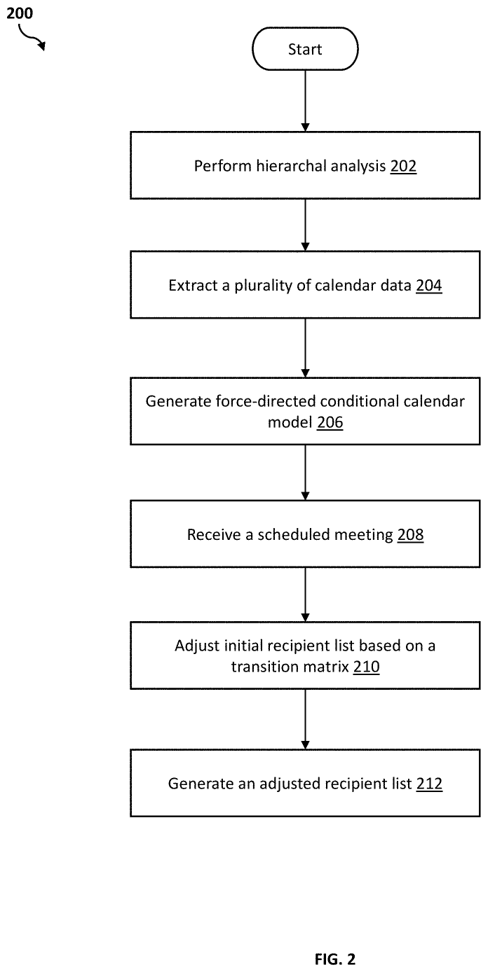

According to the present embodiment, a user using a client computer 102 or a server computer 112 may use the directed calendaring program 110a, 110b (respectively) to adjust the initial recipient list of a scheduled meeting based on a transition matrix determined for each of a plurality of users using a force-directed conditional calendar model. The directed calendaring method is explained in more detail below with respect to FIG. 2.

Referring now to FIG. 2, an operational flowchart illustrating the exemplary directed calendaring process 200 used by the directed calendaring program 110a and 110b (hereinafter directed calendaring program 110) according to at least one embodiment is depicted.

At 202, the directed calendaring program 110 performs a hierarchal analysis of an organization. The organization may be a business entity, a non-profit organization, an educational institution, or any other organization comprised of a plurality of users (e.g., employees, volunteers, students) in which meetings between users may be scheduled.

The hierarchal analysis of the organization may be based on at least organizational information, such as, but not limited to, internal documentation, an organizational directory, a management chain, job descriptions, employee titles, user profiles, amongst other organizational information. The directed calendaring program 110 may not perform the hierarchal analysis of the organization prior to receiving consent from the organization and/or an authorized user of the organization. The directed calendaring program 110 may utilize one or more tools and/or techniques, such as, but not limited to, the Galton-Watson branching process, the Lightweight Directory Access Protocol (LDAP), amongst other hierarchal analysis techniques, in performing the hierarchal analysis of the organization.

The directed calendaring program 110 may generate a hierarchal organizational structure based on the hierarchal analysis of the organizational information. The hierarchal organizational structure may be a directory information tree (DIT) illustrating a position of the plurality of users relative to one another within the organization. For example, the employees of a business entity.

At 204, the directed calendaring program 110 extracts calendar data for the plurality of users of the organization. The calendar data may be comprised of data with respect to a plurality of previously conducted meetings, including, but not limited to including, prior meeting minutes, meeting transcripts, invite records, attendance records, length of meetings, meeting times, meeting subjects or descriptions, whether the meeting is a recurring or one time meeting, chat discussions, amongst other calendar data. The directed calendaring program 110 may not extract data in violation of any law with respect to privacy protection. The directed calendaring program 110 may only extract calendar data for the plurality of users of the organization after receiving consent from the plurality of users and/or the organization.

The directed calendaring program 110 may analyze the calendar data for the plurality of users utilizing one or more linguistic analysis techniques. The one or more linguistic analysis techniques may include, but are not limited to including, a machine learning model with Natural Language Processing (NLP), Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of international Business Machines Corporation in the United States, and/or other countries), IBM Watson® Speech to Text, IBM Watson® Tone Analyzer, IBM Watson® Natural Language Understanding, IBM Watson® Natural Language Classifier, amongst other implementations.

The directed calendaring program 110 may generate a topic model for each of the plurality of previously conducted meetings. The directed calendaring program 110 may store the topic model for each of the plurality of previously conducted meetings in a knowledge corpus (e.g., database 114). The topic model may include, but is not limited to including, a list of topics and subtopics discussed at a previously conducted meeting, which list of topics and/or subtopics may be ranked by a frequency and/or an amount of time in which the topics and subtopics were discussed.

The directed calendaring program 110 may further utilize the one or more linguistic analysis techniques to understand a participation of each of the plurality of users in each of the previously conducted meetings. The participation of the user may be utilized to at least generate a topic profile for each of the plurality of users and, as will be explained in more detail below with respect to step 208, determine a likelihood of participation in a scheduled meeting. The topic profile for each of the plurality of users may include a ranked list of topics and/or subtopics in which a user has had the highest quality of participation. The highest quality of participation may be equated to a level of expertise, relative to other users of the organization with regard to a particular topic.

At 206, the directed calendaring program 110 generates a force-directed conditional calendar (FDCC) model. The FDCC model may be a statistical memoryless model utilized in determining a transition matrix for each of the plurality of users. The transition matrix may be a probability of a user transitioning from a passive to an active state in the scheduled meeting. The transition matrix of the user may be a numerical value between 0 and 1. The directed calendaring program 110 may utilize the FDCC model in determining the transition matrix for each of the plurality of users within the organization for a scheduled meeting. As will be explained in more detail below, the transition matrix determined by the FDCC model may be based on at least participation of the of the user in a previous meeting with a highest similarity score and a position of the user within a hierarchal organizational structure.

At 208, the directed calendaring program 110 receives a scheduled meeting. The scheduled meeting may be an electronic communication in which there is an initial recipient list. The initial recipient list may be comprised of at least two or more of the plurality of users of the organization. The directed calendaring program 110 may utilize information for the scheduled meeting in order to determine a previous meeting (e.g., an n−1 meeting, where n is a scheduled meeting) for each of the plurality of users within the organization. Information for the scheduled meeting may include, but is not limited to including, a subject line, a meeting agenda, whether the meeting is a recurring or one time meeting, and an initial recipient list of the scheduled meeting, amongst other information.

The directed calendaring program 110 may generate a new topic model for the scheduled meeting utilizing the one or more linguistic analysis techniques outlined above with respect to Step 204 based on the information of the scheduled meeting. The directed calendaring program 110 may identify the previous meeting (e.g., an n−1 meeting, where n is a scheduled meeting) for each of the plurality of users based on a highest similarity score between the new topic model for the scheduled meeting and the topic model for each of the plurality of previously conducted meetings stored in the knowledge corpus (e.g., database 114) in which a user was a participant and/or included on a recipient list of the previously conducted meeting.

The directed calendaring program 110 may identify the previous meeting with the highest similarity score for each user by determining a similarity score between the new topic model of the scheduled meeting and the topic model for each of the previously conducted meetings. The similarity score between each topic model and the new topic model may be determined using the one or more linguistic analysis techniques described above with respect to step 204, such as, for example, Semantic Textual Similarity (STS). The directed calendaring program 110 may weight the similarity score based on at least the recency of the previously conducted meetings and whether the scheduled meeting is a recurring or one time meeting. The similarity scores for each may be ranked for each user in determining the previous meeting for each of the plurality users. The highest ranked previously conducted meeting for each user may be the previous meeting for each user.

For example, Scheduled Meeting 1 may be a recurring monthly meeting, and accordingly, the similarity score for the corresponding meeting last month may be weighted more than a meeting conducted 11 days prior. Scheduled Meeting 2 may be a one-time meeting, accordingly, the similarity score for a meeting conducted 11 days ago may be weighted more than a meeting conducted 2 months ago such that the meeting 11 days ago may be utilized as the previous meeting if the topic model for Scheduled Meeting 2, the meeting conducted 11 days ago, and the meeting conducted 2 months ago are equivalent or within a similarity deviance.

The directed calendaring program 110 may determine a probability of participation of each user based on the participation of the user in the meeting with the highest similarity score. The participation for each of the plurality of users may be determined based on at least meeting attendance, quantity of participation, and quality of participation in the previous meeting (e.g., n−1 meeting) using the one or more linguistic analysis techniques described in step 204 above in evaluating the chat transcript of previous meeting with the highest similarity score for each user. For example, a substantive question or answer of a user may be weighted significantly higher while a greeting or salutation of a user may be assigned a weight of 0. The directed calendaring program 110 may utilize a trained machine learning model in determining the probability of participation for each user.

The directed calendaring program 110 may determine a participation score for the previous meeting for each of the plurality of users which may be based on a user's participation in a previous meeting. The participation score may be a numerical value between 0 and 1, where 0 may be the lowest probability of participation and 1 may be the highest probability of participation for the scheduled meeting. The participation score may be one input for the FDCC model in determining the transition matrix for each user.

The directed calendaring program 110 may evaluate a position of the user within the hierarchal organizational structure for the scheduled meeting relative to an initial recipient list. The initial recipient list may include at least two or more users. The directed program 110 may utilize at least the users included in the initial recipient list and the hierarchal organizational structure generated in step 202 above in evaluating the position of the user within the hierarchal structure of the scheduled meeting. The directed calendaring program 110 may also utilize the initial recipient list to determine a compatibility of each user of the initial recipient within the hierarchal organizational structure. For example, in a directory information tree (DIT) each user (e.g., object) has a distinguished name (DN) which is a sequence of relative distinguished names (RDN) which defines the attributes of the user (e.g., object). The directed calendaring program 110 may evaluate whether there are outliers, users on the initial recipient list which may be incompatible, based on the hierarchal organizational structure. The directed calendaring program 110 may also evaluate users not on the initial recipient list that based on the hierarchal organizational structure may be compatible within the hierarchal organizational structure of the initial recipient list.

The directed calendaring program 110 may determine a hierarchal score for the scheduled meeting for each of the plurality of users based on the evaluation of the position of the user relative to the two or more users of the initial recipient list. The hierarchal score for the scheduled meeting may be a numerical value between 0 and 1, where 0 may be the lowest hierarchal score (e.g., user is incompatible with the two or more users of the initial recipient list), and 1 may be the highest hierarchal score (e.g., user is compatible with the two or more users of the initial recipient list). The hierarchal score may be one input for the FDCC model in determining the transition matric for each user.

For example, the directed calendaring program 110 may determine a user may who has switched roles may be incompatible within the initial recipient list based on the hierarchal organizational structure and may assign a low (or lower) hierarchal score for the user or may identify a user not on the initial recipient list (e.g., another user who is part of the directed calendaring program 110) may be compatible within the hierarchal organizational structure relative to the initial recipient list and assign a high hierarchal score for the user.

In an embodiment, the directed calendaring program 110 may determine a topic score based on the topic profile of the user determined at step 204 above. The directed calendaring program 110 may determine a topic score for each of the plurality of users based on a comparison of the topic model of the scheduled meeting and the topic profile of the user. The topic score for the scheduled meeting may be a numerical value between 0 and 1, where 0 is the lowest topic score and 1 is the highest topic score.

At 210, the directed calendaring program 110 adjusts the initial recipient list of the scheduled meeting. The directed calendaring program 110 may adjust the initial recipient list of the scheduled meeting using the FDCC model (as described previously with respect to step 206 above). The input for the FDCC model may include at least the participation score and hierarchal score for each user with respect to the scheduled meeting.

The FDCC model may generate a transition matrix as the output for each of the plurality of users. As a result of the transition matrix value generated by the FDCC model(s) for each of the plurality of users, the directed calendaring program 110 may adjust the initial recipient list of the scheduled meeting, such that one or more users of the plurality of the users may be absorbed to an adjusted recipient list (e.g., added to an adjusted recipient list) and/or one or more users be deflected from the adjusted recipient (e.g., removed from the initial mailing list, not added to the adjusted recipient list). The transition matrix value may be a probability function of the model (e.g., probability a user transitions from a passive to an active state for a scheduled meeting). The transition matrix value may be a numerical value between 0 and 1, where 0 represents a user likely to remain in a passive state while 1 represents a user likely to transition into an active state.

The directed calendaring program 110 may utilize an initial baseline score greater than 0.5 as a threshold value by which to absorb and/or deflect users. The directed calendaring program 110 may compare the transition matrix value with the initial baseline score in determining whether to absorb one or more users of the plurality of users and/or deflect one or more users of the initial recipient list. For example, User 1 may not be included in the initial recipient list and User 2 may be part of initial recipient list. The directed calendaring program 110 may generate a transition matrix value of 0.8 for User 1 and 0.2 for User 2. Accordingly, the directed calendaring program 110 may absorb User 1 and deflect User 2, such that User 1 is included on the adjusted recipient list and User 2 is removed from the adjusted recipient list, as will be explained in more detail below. The directed calendaring program 110 may incrementally adjust the initial baseline score as the FDCC model becomes more asymptotic with every iteration for a scheduled meeting.

In an embodiment, the directed calendaring program may utilize a recipient's threshold by which the initial recipient list of the scheduled meeting may not be adjusted. The recipient's threshold may be a default rule and/or may be configured by the organization and/or an authorized user of the organization. For example, the recipient's threshold may not allow the directed calendaring program 110 to deflect users if the initial recipient list is below a certain number or allow the directed calendaring program 110 to absorb more than a certain percentage of the plurality of users.

At 212, the directed calendaring program 110 generates an adjusted recipient list. The adjust recipient list may be the initial recipient list minus the deflected one or more initial recipient users and/or plus the one or more of the plurality of users absorbed. The directed calendaring program 110 may transmit the scheduled meeting to the adjusted recipient list.

The directed calendaring program 110 may include additional information with the scheduled meeting transmitted to the one or more of the plurality users absorbed based on the transition matrix value. The additional information may include, but is not limited to including, details with respect to the user's inclusion on the adjusted recipient list. For example, User 1 and User 2 both may have been absorbed to the adjusted recipient list. User 1 may have had a high hierarchal score and User 2 had a high topic score. The additional information included in the scheduled meeting transmitted to User 1 may include a message such as “users within similar roles of your organization are attending this meeting” and the additional information included in the scheduled meeting transmitted to User 2 may include a message such as “users with similar interests within your organization are attending this meeting.”

The directed calendaring program 110 may also send notifications to users deflected from the scheduled meeting. The directed calendaring program 110 include an option within the notification for the users deflected from the scheduled meeting to receive the chat transcript of the meeting and/or monitor in real time the chat transcript of the scheduled meeting as it is transcribed utilizing the one or more linguistic analysis techniques.

The directed calendaring program 110 may also send notifications based on a topic being discussed within the meeting that may have not been derived from the information of the scheduled meeting. The directed calendaring program may generate a chat transcript for the scheduled meeting in real time and utilize the topic profile for each of the plurality of users stored in the knowledge corpus (e.g., database 114) in sending the notifications. The directed calendaring program 110 may send notifications to join the scheduled meeting to one or more absent users (e.g., users not in attendance). For example, the agenda for Scheduled Meeting 1 included Topics A, B, and C, however utilizing the linguistic analysis techniques the directed calendaring program 110 may determine Topic D is currently being discussed. The directed calendaring program 110 may identify users for which Topic D is ranked highly on their topic profile and may notify the identified users of the discussion of Topic D within Scheduled Meeting 1 allowing the users to directly join a live discussion.

The directed calendaring program 110 may also generate a hybrid recipient list, whereby based on the transition matrix value of a user the user may be recommended to attend a meeting for a specific time interval. For example, 15 minutes of a 2 hour meeting.

It may be appreciated that FIG. 2 and provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the directed calendaring program 110a in client computer 102, and the directed calendaring program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the directed calendaring program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the directed calendaring program 110a in client computer 102 and the directed calendaring program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the directed calendaring program 110a in client computer 102 and the directed calendaring program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

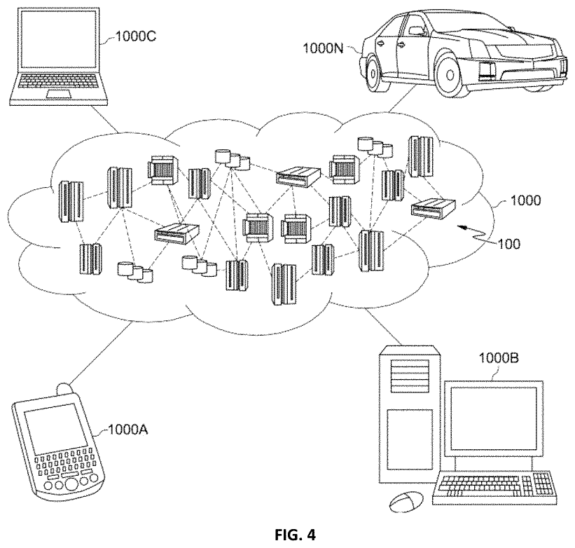

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

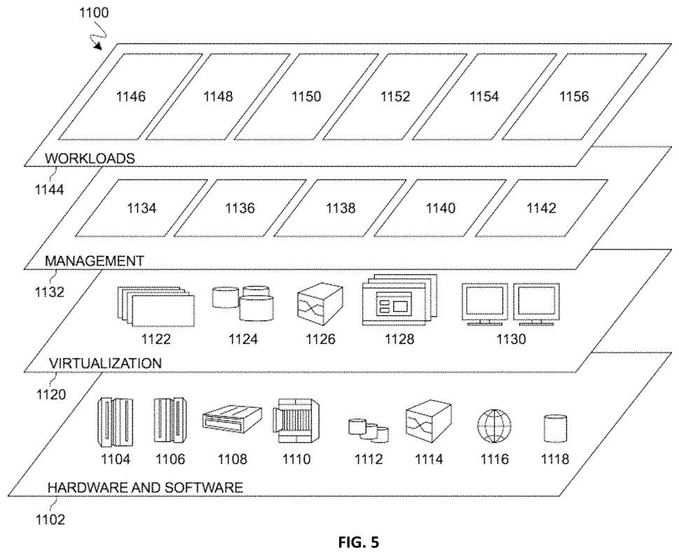

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and directed calendaring program 1156. A directed calendaring program 110a, 110b provides a way to optimize meeting participation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for directed calendaring, the method comprising:
generating a topic model for each of a plurality of previously conducted meetings based on calendar data for a plurality of users;
receiving a scheduled meeting, the scheduled meeting including an initial recipient list;
generating a new topic model for the scheduled meeting;
identifying a previous meeting with a highest similarity score between the topic model and the new topic model for each of the plurality of users; and
adjusting the initial recipient list of the scheduled meeting based on a transition matrix, wherein the transition matrix is determined for each of the plurality of users based on at least participation in the previous meeting and a position within a hierarchal organizational structure.

2. The method of claim 1, wherein identifying the previous meeting with the highest similarity score for each of the plurality of users further comprises:
determining a similarity score between the topic model for each of the plurality of previously conducted meetings and the new topic model for the scheduled meeting;
weighting each of the similarity scores based on at least recency of the previously conducted meetings and whether the previously conducted meetings are a recurring or a one-time meeting; and
ranking the similarity scores for each of the plurality of users.

3. The method of claim 1, wherein the transition matrix represents a probability of a user transitioning from a passive to an active state in the scheduled meeting, wherein the transition matrix is determined based on at least the participation of the of the user in the previous meeting with the highest similarity score and the position of the user within the hierarchal organizational structure.

4. The method of claim 3, wherein the position of the user within the hierarchal organizational structure is determined relative to users of the initial recipient list.

5. The method of claim 1, wherein the transition matrix is determined for each of the plurality of users using a force-directed conditional calendar model, and wherein the transition matrix depicts a numerical value between 0 and 1.

6. The method of claim 5, further comprising:
absorbing, to an adjusted recipient list, each user where the transition matrix exceeds a threshold; and
deflecting, from the adjusted recipient list, each user where the transition matrix is less than or equal to the threshold.

7. The method of claim 6, further comprising:
generating the adjusted recipient list; and
transmitting the scheduled meeting to the adjusted recipient list.

8. The method of claim 6, further comprising:
sending a notification to each user deflected from the adjusted recipient list, the notification including an option to monitor a chat transcript of the scheduled meeting, wherein the chat transcript is generated in real time.

9. The method of claim 1, further comprising:
determining a topic profile for each of the plurality of users;
generating a chat transcript for the scheduled meeting in real time; and
sending a notification to join the scheduled meeting to one or more absent users based on at least the chat transcript and the topic profile of the one or more absent users.

10. A computer system for directed calendaring, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a topic model for each of a plurality of previously conducted meetings based on calendar data for a plurality of users;
receiving a scheduled meeting, the scheduled meeting including an initial recipient list;
generating a new topic model for the scheduled meeting;
identifying a previous meeting with a highest similarity score between the topic model and the new topic model for each of the plurality of users; and
adjusting the initial recipient list of the scheduled meeting based on a transition matrix, wherein the transition matrix is determined for each of the plurality of users based on at least participation in the previous meeting and a position within a hierarchal organizational structure.

11. The computer system of claim 10, wherein identifying the previous meeting with the highest similarity score for each of the plurality of users further comprises:
determining a similarity score between the topic model for each of the plurality of previously conducted meetings and the new topic model for the scheduled meeting;
weighting each of the similarity scores based on at least recency of the previously conducted meetings and whether the previously conducted meetings are a recurring or a one-time meeting; and
ranking the similarity scores for each of the plurality of users.

12. The computer system of claim 10, wherein the transition matrix represents a probability of a user transitioning from a passive to an active state in the scheduled meeting, wherein the transition matrix is determined based on at least the participation of the of the user in the previous meeting with the highest similarity score and the position of the user within the hierarchal organizational structure.

13. The computer system of claim 12, wherein the position of the user within the hierarchal organizational structure is determined relative to users of the initial recipient list.

14. The computer system of claim 10, wherein the transition matrix is determined for each of the plurality of users using a force-directed conditional calendar model, and wherein the transition matrix depicts a numerical value between 0 and 1.

15. The computer system of claim 14, further comprising:
absorbing, to an adjusted recipient list, each user where the transition matrix exceeds a threshold; and
deflecting, from the adjusted recipient list, each user where the transition matrix is less than or equal to the threshold.

16. The computer system of claim 15, further comprising:
generating the adjusted recipient list; and
transmitting the scheduled meeting to the adjusted recipient list.

17. A computer program product for directed calendaring, comprising:
one or more non-transitory computer-readable storage media and program instructions stored on at least one of the one or more tangible storage media, the program instructions executable by a processor to cause the processor to perform a method comprising:
generating a topic model for each of a plurality of previously conducted meetings based on calendar data for a plurality of users;
receiving a scheduled meeting, the scheduled meeting including an initial recipient list;
generating a new topic model for the scheduled meeting;
identifying a previous meeting with a highest similarity score between the topic model and the new topic model for each of the plurality of users; and
adjusting the initial recipient list of the scheduled meeting based on a transition matrix, wherein the transition matrix is determined for each of the plurality of users based on at least participation in the previous meeting and a position within a hierarchal organizational structure.

18. The computer program product of claim 17, wherein identifying the previous meeting with the highest similarity score for each of the plurality of users further comprises:
determining a similarity score between the topic model for each of the plurality of previously conducted meetings and the new topic model for the scheduled meeting;
weighting each of the similarity scores based on at least recency of the previously conducted meetings and whether the previously conducted meetings are a recurring or a one-time meeting; and
ranking the similarity scores for each of the plurality of users.

19. The computer program product of claim 17, wherein the transition matrix represents a probability of a user transitioning from a passive to an active state in the scheduled meeting, wherein the transition matrix is determined based on at least the participation of the of the user in the previous meeting with the highest similarity score and the position of the user within the hierarchal organizational structure.

20. The computer program product of claim 19, wherein the position of the user within the hierarchal organizational structure is determined relative to users of the initial recipient list.
